(19) United States
(12) Patent Application Publication
(10) Pub. No.: US 2010/0126301 A1
(43) Pub. Date: May 27, 2010

(54) GRIP FOR BICYCLE HANDLEBARS

(75) Inventor: Tsai-Yun YU, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: Internation Bicycle Products Corporation, Tachia (TW)

(21) Appl. No.: 12/389,527

(22) Filed: Feb. 20, 2009

(30) Foreign Application Priority Data
Nov. 26, 2008 (TW) 97221206

(51) Int. Cl. B62K 21/26

(52) U.S. Cl. 74/551.9

(57) ABSTRACT

A bicycle handlebar grip includes a cylindrical sleeve made of a material sufficiently rigid to retain the shape of the grip. The sleeve has an open end to be pierced therein by one end of a handlebar of a bicycle. A resilient intermediate layer tightly covers the surface of the sleeve. A strip then spirally wraps about said intermediate layer to be an outer layer of the grip.

### BACKGROUND OF THE INVENTION

1. Field of the Invention

The present invention generally relates to bicycle handlebar grips, particularly to a bicycle handlebar grip with an outer layer formed by a spirally wrapped strip.

2. Description of the Related Art

It is well known that, for decades, cylindrical handlebar grips have been utilized on the ends of bicycle handlebars to improve a cyclist's ability to grasp the handlebars of the bicycle. These grips typically consist of a cylindrical rigid body and an over molding elastomer. The primary disadvantage of such a prior art grip is that the over-molded elastomer can not be easily replaced when damaged by normal wear and tear.

Thus, there is a need for a new bicycle handlebar grip with an outer layer that can be easily attached and removed.

### SUMMARY OF THE INVENTION

A bicycle handlebar grip in accordance with the present invention includes a cylindrical sleeve made of a material sufficiently rigid to retain the shape of the grip. The sleeve has an open end to be pierced therein by one end of a handlebar of a bicycle. A resilient intermediate layer tightly covers the surface of the sleeve. A strip then spirally wraps about said intermediate layer to be an outer layer of the grip.

### BRIEF DESCRIPTION OF THE DRAWINGS

The present invention may be more clearly understood with reference to the following detailed description, in conjunction with the appended drawings of which:

FIG. 1 is a perspective view of a handlebar grip in accordance with the present invention mounted on one end of a bicycle handlebar;

FIG. 2 is an exploded view of the handlebar grip of FIG. 1;

FIG. 3 is a partly exploded view of the handlebar grip of FIG. 1;

FIG. 4 is a cross-sectional view taken along the line 4-4 of FIG. 1; and

FIG. 5 is a cross-sectional view taken along the line 5-5 of FIG. 1.

### DETAILED DESCRIPTION OF THE INVENTION

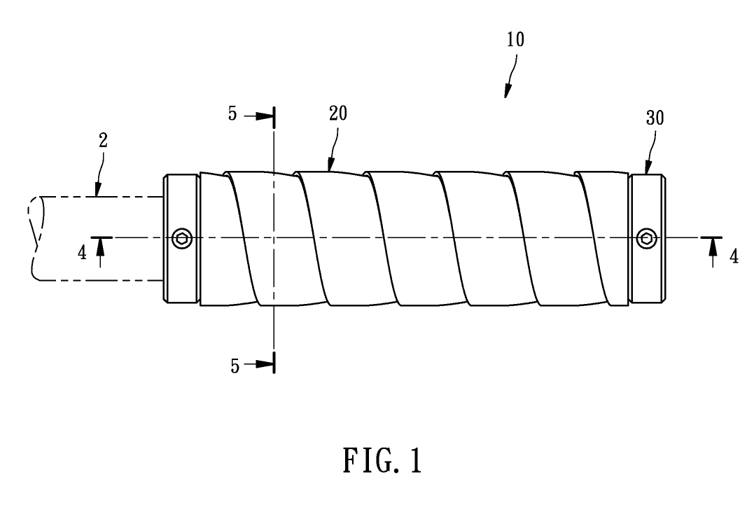

Referring firstly to FIG. 1, a handlebar grip 10 according to the present invention is fitted to one end of a handlebar 2 of a bicycle. An outer layer 20 of the grip 10 and a tightening means 30 can be seen in this drawing.

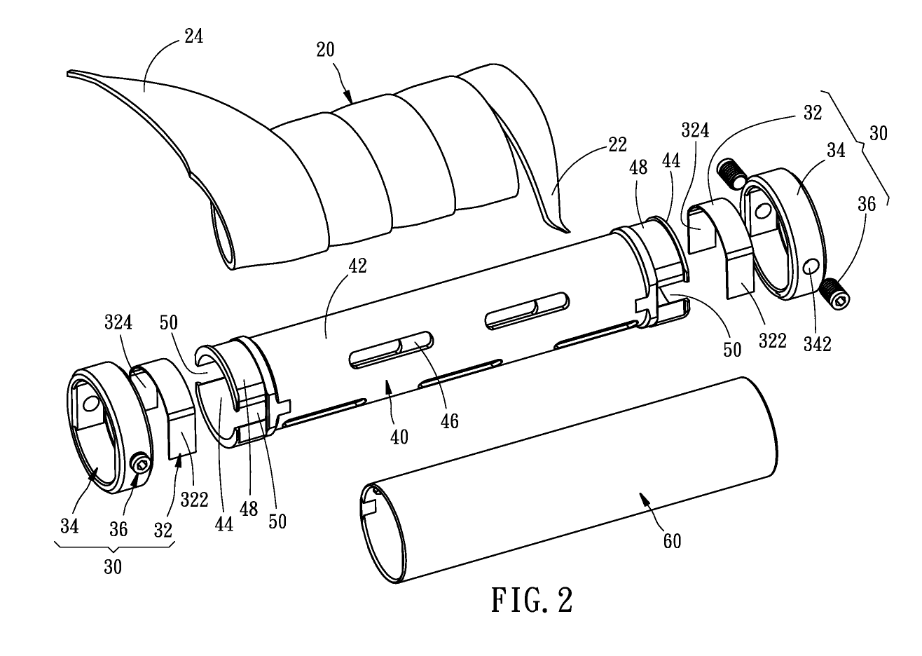

Referring secondly to FIGS. 2-5, it can be seen that, in addition to outer layer 20 and tightening means 30, grip 10 also includes a cylindrical sleeve 40 and an intermediate layer 60.

Cylindrical sleeve 40 is an injection molded article formed from suitable rigid plastic materials such as PP or PA, to be a unitary underlying support structure. It has a cylindrical body 42 with two open ends 44 provided respectively on each side thereof. A number of elongated slots 46 extend axially along a lengthwise portion of cylindrical body 42. Each of open ends 44 is provided an annular flange 48 with a pair of gaps 50 oppositely disposed thereon.

Intermediate layer 60 is cylindrically shaped and made of a resilient material with anti-skid characteristics. In this embodiment, it is a molded article formed from synthetic rubber. Intermediate layer 60 is tightly attached to and covers the surface of cylindrical body 42 of cylindrical sleeve 40.

Outer layer 20 is an elongated strip made of leather, fabric or plastic materials in a variety of colors. In this embodiment, outer layer 20 has a front tapered end 22 and a rear tapered end 24. During assembly, it is spirally wrapped about the surface of intermediate layer 60 in such a way that each of tapered ends 22 and 24 is respectively and firmly attached to each of annular flanges 48.

Tightening means 30 is used to securely mount grip 10 on one end of handlebar 2. It includes a biasing member 32, a tightening ring 34 and a fastener 36. Biasing member 32 is made of resilient metals and is C-shaped to have a first flat end 322 and a second flat end 324. Biasing member 32 nests in annular flange 48 in such a way that first end 322 fits in one gap 50 thereof and second end 324 fits in another gap 50 thereof.

Tightening ring 34 has two threaded through holes 342 oppositely disposed and is sleeved onto the surface of annular flange 48 of grip body 42 in such a way that biasing member 32 is sandwiched between tightening ring 34 and annular flange 48 of grip body 42 and each of threaded through holes 342 respectively aims at first flat end 322 and second flat end 324 of biasing member 32.

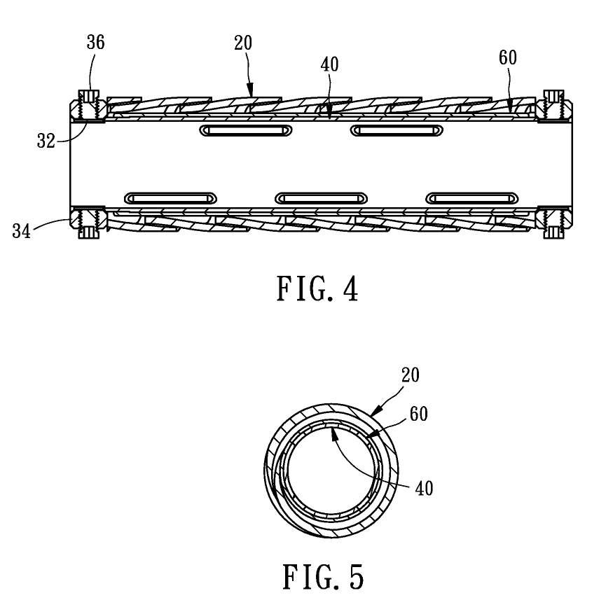

Fastener 36, in this embodiment, is a bolt. It threads through threaded hole 342 of tightening ring 34 and engages therewith in such a way that a bottom end of fastener 36 protrudes out of threaded through hole 342 to lean against first flat end 322 of biasing member 32 so that annular flange 48 of grip body 42 clamps tightly against one end of handlebar 2, as shown in FIG. 4.

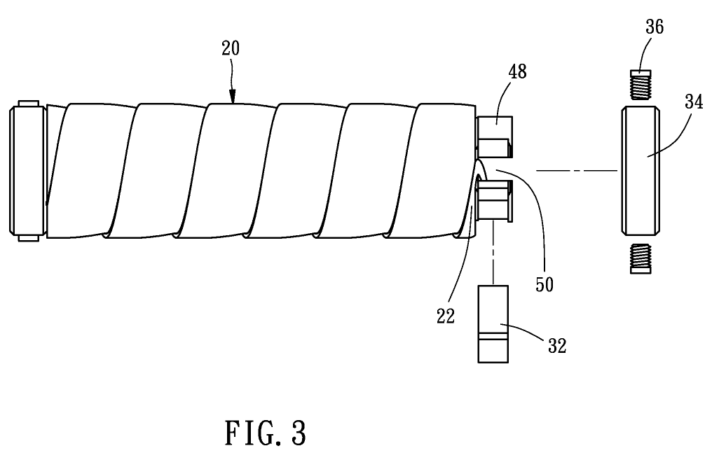

During assembly, before nesting biasing member 32, tapered ends 22 and 24 of outer layer strip 20 are respectively inserted into gaps 50 of annular flanges 48, as shown in FIG. 3, so that after biasing member 32 nests therein, each end of strip 20 is firmly attached to grip body 42.

What is claimed is:

1. A grip for bicycle handlebars, comprising:
a cylindrical sleeve having an open end;
a resilient intermediate layer tightly covering the surface of said sleeve; and
a strip spirally wrapped about said intermediate layer.

2. The grip of claim 1, wherein said sleeve has a rigidness greater than that of said intermediate layer.

3. The grip of claim 1, wherein said intermediate layer is made of resilient materials with anti-skid characteristics.

4. The grip of claim 1, wherein said intermediate layer comprises rubber materials.

5. The grip of claim 1, wherein said strip is made of plastic materials.

6. The grip of claim 1, wherein said strip is made of fabric materials.

7. The grip of claim 1, wherein said strip is made of leather materials.

8. The grip of claim 1, further comprising a tightening means disposed on said open end of said sleeve.

9. The grip of claim 8, wherein said open end of said sleeve is provided an annular flange with a pair of gaps oppositely disposed thereon.

10. The grip of claim 9, wherein said tightening means includes:
a biasing member made of resilient metals and being C-shaped with a first flat end and a second flat end, said biasing member being nested in said annular flange of said sleeve in such a way that said first flat end fits in one gap thereof and second flat end fits in another gap thereof;
a tightening ring having two threaded through holes oppositely disposed and being sleeved onto a surface of said annular flange of said sleeve in such a way that said biasing member is sandwiched between said tighten ring and said annular flange of sleeve and each of said threaded through holes thereof respectively aims at said first flat end and said second flat end of said biasing member; and
a bolt threading through said threaded hole of said tightening ring and engaging therewith in such a way that a bottom end of said bolt protrudes out of said threaded through hole to lean against said first flat end of said biasing member so that said annular flange of said sleeve clamps tightly against one end of bicycle handlebar.

11. The grip of claim 10, wherein said strip has tapered ends inserted into said gaps of said annular flanges of said sleeve.
